(19) United States
(12) Patent Application Publication
(10) Pub. No.: US 2010/0017699 A1
(43) Pub. Date: Jan. 21, 2010

(54) MULTI-CHOICE CONTROLS FOR SELECTING DATA GROUPS TO BE DISPLAYED

(76) Inventors: Glenn H. Farrell, Peoria, IL (US); Gary J. Rhodes, Springfield, IL (US)

Correspondence Address: Russ Weinzimmer, 614 Nashua Street, Suite 53, Milford, NH, 03055, US

(21) Appl. No.: 12/176,399

(22) Filed: Jul. 20, 2008

(51) Int. Cl. G06F 3/14

(52) U.S. Cl. 715/227

(57) ABSTRACT

A software tool and method of use are disclosed that enable convenient and rapid selection of columns, rows, or other data groups for presentation on a display by an electronic device. One or more information display regions is provided, and controls such as drop-down lists or buttons are used to select a data group for each location from lists of allowed choices. In this way, a user is not required to select each data group from among all possible choices. In preferred embodiments, data group lists can include a null choice that causes no information to be displayed. In further embodiments, sorting controls enable sorting of associated information display regions, and in some of these embodiments sorting one information display region sorts all the other information display regions correspondingly. In some embodiments, the electronic device communicates with the electronic display over a network or over the internet.

### FIELD OF THE INVENTION

The invention generally relates to presenting information on an electronic display, and more specifically to controlling the selection and order of data groups displayed on an electronic display.

### BACKGROUND OF THE INVENTION

Computers and other electronic devices frequently display information in data groups, such as in rows or columns with individual items of information displayed in cells in the rows or columns. Frequently, a plurality of data groups is presented, such as rows or columns aligned to form a table. For example, a computer used to manage a customer mailing list for a business may display information regarding a group of customers in a table, wherein each row corresponds to a customer and each column corresponds to a type of information about a customer, such as a first name, last name, telephone number, email address, and so forth.

Due to size and resolution limitations, it is not always possible to display all of the available data groups simultaneously on an electronic display. This problem is especially severe when the electronic display is part of a compact, hand-held device, and/or when the data groups are to be presented together with other information on the display. One approach is to adjust the order in which data groups are displayed, so as to ensure that the data groups of greatest interest can be displayed simultaneously. However, this approach does little to address the common situation where different data groups are of interest under different circumstances.

Another approach is to allow a display to “scroll” over a set of data groups that occupies a much larger virtual space, so as to bring different data groups into view as needed. Some of these approaches also allow certain data groups to be “fixed” in location on the display while other data groups scroll past them, thereby allowing a user to rapidly display different movable data groups next to the fixed data groups. However, this approach provides very limited flexibility as to which data groups can be selected and displayed.

Some software tools that provide for tabular display of database information allow a user to control the selection and order of displayed rows or columns by constructing a so-called “query.” Typically, all of the available row or column headings (also known as “field” names in database terminology) are made available in a table or drop-down list, and are clicked or dragged onto a query form so as to select which rows or columns are displayed and in what order. However, this approach requires that a separate query be constructed for each desired combination and order of rows or columns to be displayed, which can be burdensome and time consuming.

### SUMMARY OF THE INVENTION

A software tool and method of use are claimed that enable convenient and rapid selection of the data groups presented on an electronic display. An information display region is provided on the display, and a column selecting software control, such as a drop-down list or a button, is used to select a data group to be presented in the information display region. In preferred embodiments, the information display regions are column locations, and the data groups are displayed as columns. In typical embodiments, a plurality of information display regions is provided, and a data-group-selecting software control is associated with each of the information display regions. In various preferred embodiments, a data group is selected by using a pointing device to select the desired data group from a list displayed by a drop-down box, or by using a button to advance through a list of choices until the desired data group is reached.

In preferred embodiments, the flexibility and convenience with which data groups are selected is optimized by allowing a different list of available data group choices to be defined for each of the data-group-selecting software controls. In this way, a user is not required to select each data group from among all possible choices, but is instead required only to choose data groups from shorter, pre-defined lists that are appropriate for each information display region.

In some preferred embodiments, data-group-selecting software controls can include null choices that cause no information to be displayed in an information display region. In some preferred embodiments the information displayed in an information display region can be sorted using a sort control. And in some of these embodiments where a plurality of information display regions is displayed, activation of a sorting control associated with one information display region causes the information in all of the information display regions to be sorted.

In one general aspect of the invention, an article of manufacture is disclosed that includes media containing software that is able to control an electronic device having access to data groups of information. The software is able to cause the electronic device to present on at least one electronic display an information display region that is able to display information from a data group, and a data-group-selecting control cooperative with the information display region. The data-group-selecting control enables a user to select a data group from among data groups accessible to the electronic device, thereby causing information from the selected data group to be displayed in the information display region.

In preferred embodiments, a plurality of information display regions and a plurality of data-group-selecting controls is presented on the at least one electronic display, each data-group-selecting control being cooperative with a information display region. In some preferred embodiments the data-group-selecting control enables a user to select a data group from among a defined sub-set of the data groups accessible to the electronic device.

In certain preferred embodiments the data-group-selecting control is a drop-down box that presents a list of data group choices from among the data groups accessible to the electronic device and enables a user to select one of the data group choices. In other preferred embodiments, the data-group-selecting control is a button that enables a user to cycle through a list of data group choices from among the data groups accessible to the electronic device until a desired data group choice is reached.

In various preferred embodiments, the data-group-selecting control enables a user to select a null choice, thereby causing no information to be presented in the information display region.

Preferred embodiments include a sorting control cooperative with the information display region, the sorting control enabling a user to sort information items included in a data group displayed in the information display region. And in some of these preferred embodiments where a plurality of information display regions is presented on the at least one electronic display, the sorting control enables a user to sort the information items included in all displayed data groups according to the sorting of the information items included in the data group that is cooperative with the sorting control.

A second general aspect of the invention is a method for selecting data groups for presentation on at least one electronic display. The method includes operating an electronic device that has access to data groups of information and is controlled by software. The method further includes causing the electronic device to present on at least one electronic display an information display region that is able to display information from a data group. The method also includes causing the electronic device to present on at least one electronic display a data-group-selecting control cooperative with the information display region. The data-group-selecting control enables a user to select a data group from among data groups accessible to the electronic device, thereby causing information from the selected data group to be displayed in the information display region.

In preferred embodiments, a plurality of information display regions and a plurality of data-group-selecting controls is presented on the at least one electronic display, each data-group-selecting control being cooperative with a information display region. In some preferred embodiments the data-group-selecting control enables a user to select a data group from among a defined sub-set of the data groups accessible to the electronic device.

In certain preferred embodiments the data-group-selecting control is a drop-down box that presents a list of data group choices from among the data groups accessible to the electronic device and enables a user to select one of the data group choices. In other preferred embodiments, the data-group-selecting control is a button that enables a user to cycle through a list of data group choices from among the data groups accessible to the electronic device until a desired data group choice is reached.

In various preferred embodiments, the data-group-selecting control enables a user to select a null choice, thereby causing no information to be presented in the information display region.

Preferred embodiments include a sorting control cooperative with the information display region, the sorting control enabling a user to sort information items included in a data group displayed in the information display region. And in some of these preferred embodiments where a plurality of information display regions is presented on the at least one electronic display, the sorting control enables a user to sort the information items included in all displayed data groups according to the sorting of the information items included in the data group that is cooperative with the sorting control.

In certain preferred embodiments, the electronic device is in communication with the at least one electronic display over a network. And in some of these embodiments, the network is the internet.

### BRIEF DESCRIPTION OF THE DRAWINGS

FIG. 1A illustrates a preferred embodiment in which the column selecting controls are drop-down lists;

FIG. 1B illustrates the preferred embodiment of FIG. 1A after selection of a column from a drop-down list;

FIG. 2A illustrates a preferred embodiment in which the column selecting controls are buttons;

FIG. 2B illustrates the preferred embodiment of FIG. 2A after activating one of the buttons; and

FIG. 3 illustrates a preferred embodiment in which the column selecting controls are buttons that include null choices, one of the buttons includes only one column choice, and the table is displayed in conjunction with a project tracking chart.

### DETAILED DESCRIPTION OF PREFERRED EMBODIMENTS

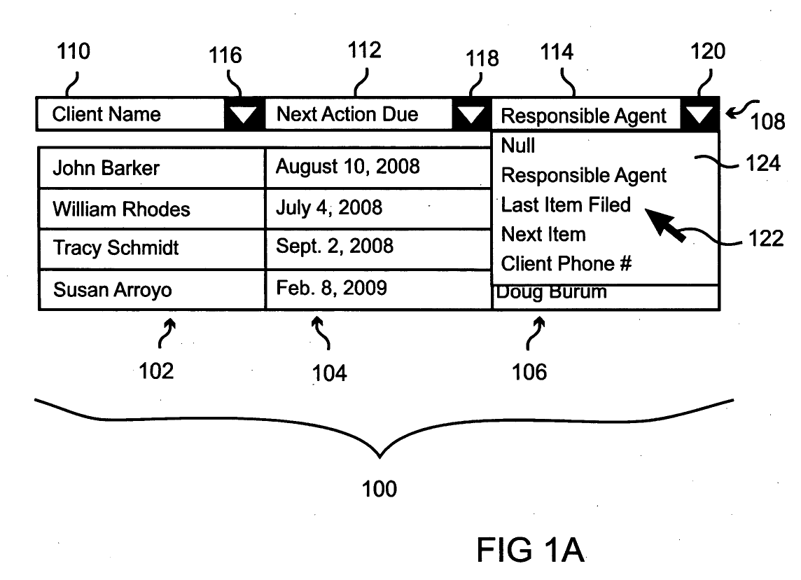

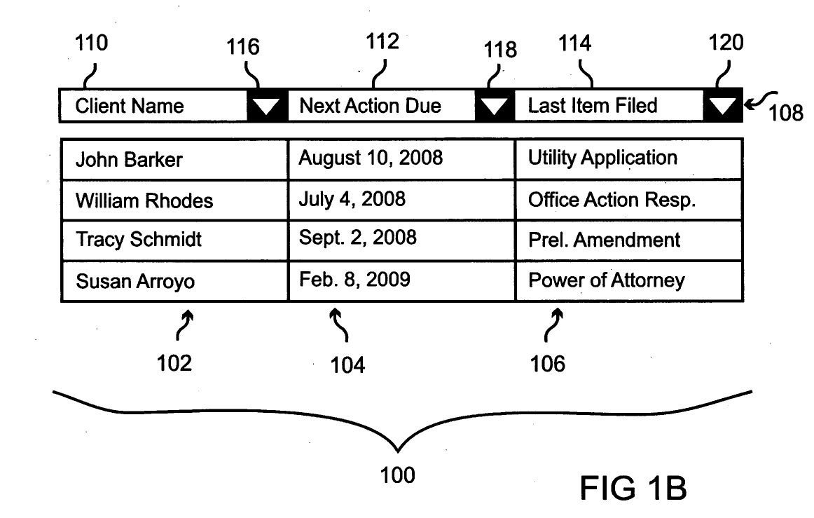

The present invention is a software tool for selecting data groups to be displayed on at least one electronic display. Information display regions are presented on the electronic display(s), together with data-group-selecting controls that are used to select the data groups that will be displayed in the information display regions. In the embodiment of FIG. 1A, data groups are presented as columns of cells forming a table, and the information display regions are therefore column locations. In the figure, the table 100 includes three column locations 102, 104, 106. Above each column location 102, 104, 106 is a column selecting control 108 that is used to select which column will be presented in each of the column locations 102, 104, 106. The column selecting controls 108 in this embodiment are drop-down boxes 110, 112, 114, each of which displays a column heading that identifies the current contents of the corresponding column location 102, 104, 106, and each of which includes an arrow 116, 118, 120 that can be activated using a pointing device such as a mouse cursor 122 so as to display a list 124 of available column choices for the corresponding column location 102, 104, 106.

In the example given in FIG. 1A, a column containing client names is presented in the first column location 102, a column containing due dates for the next actions relating to the clients is presented in the second column location 104, and a column containing the name of the agent responsible for each client is presented in the third column location 106. In the configuration shown in the figure, the arrow 120 of the drop-down box 114 corresponding to the third column location 106 has been activated, causing display of a drop-down list 124 of columns that can be presented in the third column location 106. It can be seen in the figure that the first choice is a “null” choice, which if selected would cause no information to be displayed in the third column location 106. The mouse cursor 122 is positioned in the figure so as to select a column containing “last item filed” information for each case.

FIG. 1B illustrates the result of clicking with the mouse cursor 122 on an item in the drop-down list 124 of a column selection control 108 of FIG. 1A. The column heading and the column presented in the third column location 106 have been replaced by the column heading and corresponding column selected from the drop-down list. In similar embodiments, data groups are presented in rows instead of columns. In other embodiments, data groups are presented in other formats, such that the data groups do not necessarily form a table or otherwise relate to each other.

It can be seen from FIG. 1A and FIG. 1B that drop-down lists 124 provide significant flexibility as to how many choices are made available for each column location. Within the limits of the display size and resolution, a relatively long list can be presented, and the list can be made virtually infinite if scroll bars are incorporated in the drop-down list box 124. However, this approach has the disadvantage that the choices available for a column location 102, 104, 106 are not visible until the drop down box arrow 116, 118, 120 corresponding to that column location 102, 104, 106 is activated.

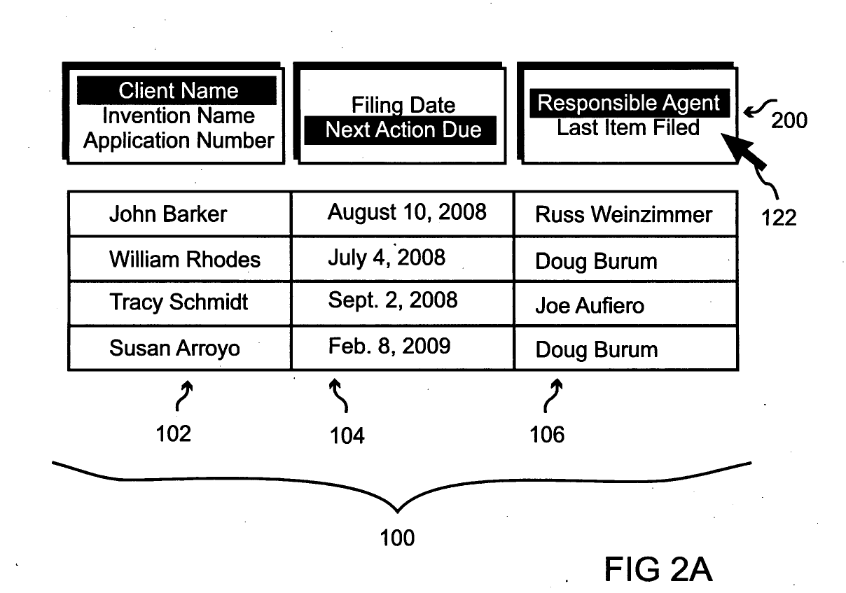

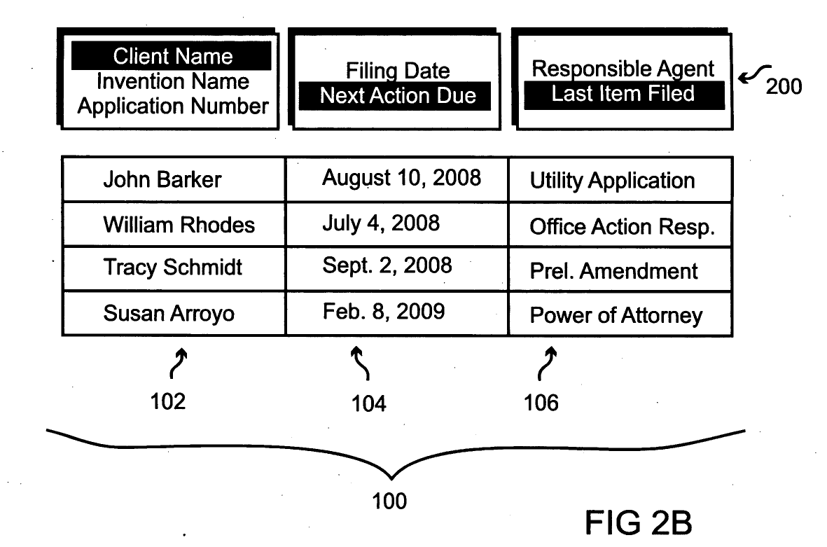

FIG. 2A illustrates an embodiment that uses buttons 200 as data-group-selecting controls. As in FIG. 1A and FIG. 1B, the data groups in this embodiment are presented as columns in column locations. Each button 200 indicates the columns that can be selected, and the current selection is highlighted. The cursor 122 is illustrated in the figure as being ready to activate the button associated with the third column location 106, causing it to change from presenting the responsible agent column to presenting the last item filed column. FIG. 2B illustrates the appearance of the display of FIG. 2A after the button has been activated by the cursor 122 as illustrated in FIG. 2A.

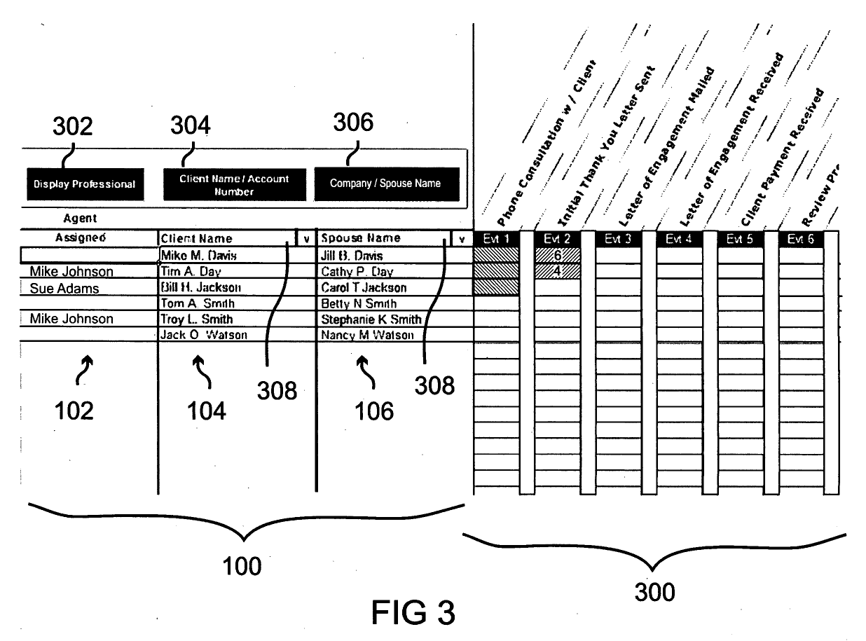

FIG. 3 illustrated an embodiment in which column data groups 102, 104, 106 are presented cooperative with other information. In the embodiment of FIG. 3, the columns are presented in alignment with a project tracking table 300 that tracks the completion of steps in projects. Each item in each of the columns 102, 104, 106 provides supporting information for a horizontally aligned project in the project table 300. Buttons 302, 304, 306 are presented as column selecting controls for each of the column locations 102, 104, 106 in the table 100. In this embodiment, the buttons only display a generic name for the category of columns that can be selected for the corresponding column location. For example, the first button 302 displays the generic heading “Display Professional” while the column heading at the top of the corresponding column 102 indicates the specific choice of “professional,” which in this case is a “Technology Advisor Assigned.” Toggling this button 302 causes the choice of column displayed in the first column location 102 to be cycled through different types of “professionals” assigned to the projects being tracked in the project tracking table 300.

Each of the other buttons 304, 306 in FIG. 3 provide two column choices for the corresponding column locations 104, 106, and both choices are indicated in the buttons themselves. For example, the second button 304 indicates that the two choices for the second column are “client name” and “account number,” and the column heading above the second column 104 indicates that the “client name” column is currently displayed.

In the embodiment of FIG. 3, sorting controls 308 are associated with the second 104 and third 106 column locations. A sorting control 308 can be activated using the mouse cursor 122 so as to simultaneously sort all of the rows in the two tables 100, 300 according to the contents of the column with which the sorting control is associated. An arrow is included next to each sorting control 308 so as to indicate the direction in which the sorting will be performed. Activating a sorting control a second time causes the arrow to change direction and the sort to be repeated in the opposite direction.

Depending on the embodiment, the information display regions of the present invention can be displayed on any electronic display, including the screen of a computer, such as a personal computer, or on the display of a hand-held device such as a personal digital assistant “PDA,” cell phone, or similar device. The computer or other electronic device that controls the information display regions can be a local device, or it can be a server computer or other electronic device that is in communication by wired or wireless means with the electronic display, for example over the internet over the telephone network, or over some other network.

Other modifications and implementations will occur to those skilled in the art without departing from the spirit and the scope of the invention as claimed. Accordingly, the above description is not intended to limit the invention except as indicated in the following claims.

What is claimed is:

1. An article of manufacture comprising:
media containing software that is able to control an electronic device having access to data groups of information, the software being able to cause the electronic device to present on at least one electronic display:
an information display region that is able to display information from a data group; and
a data-group-selecting control cooperative with the information display region, the data-group-selecting control enabling a user to select a data group from among data groups accessible to the electronic device, thereby causing information from the selected data group to be displayed in the information display region.

2. The article of manufacture of claim 1, wherein the information display region is able to display information in one of a row and a column.

3. The article of manufacture of claim 1, wherein a plurality of information display regions and a plurality of data-group-selecting controls is presented on the at least one electronic display, each data-group-selecting control being associated with a respective information display region.

4. The article of manufacture of claim 1, wherein the data-group-selecting control enables a user to select a data group from among a defined sub-set of the data groups accessible to the electronic device.

5. The article of manufacture of claim 1, wherein the data-group-selecting control is a drop-down box that presents a list of data group choices from among the data groups accessible to the electronic device, and enables a user to select one of the data groups from the list.

6. The article of manufacture of claim 1, wherein the data-group-selecting control is a button that enables a user to cycle through a list of data group choices from among the data groups accessible to the electronic device until a desired data group choice is reached.

7. The article of manufacture of claim 1, wherein the data-group-selecting control enables a user to select a null choice, thereby causing no information to be presented in the information display region.

8. The article of manufacture of claim 1, further comprising a sorting control cooperative with the information display region, the sorting control enabling a user to sort information items displayed in the information display region.

9. The article of manufacture of claim 8, wherein a plurality of information display regions is presented on the electronic display, and the sorting control enables a user to sort information items displayed in all information display regions according to the sorting of the information items included in the information display region that is cooperative with the sorting control.

10. A method for selecting data groups for presentation on at least one electronic display, the method comprising:
operating an electronic device that has access to data groups of information and is controlled by software so as to cause the electronic device to present on at least one electronic display:
an information display region that is able to display information from a data group; and
a data-group-selecting control cooperative with the information display region, the data-group-selecting control enabling a user to select a data group from among data groups accessible to the electronic device, thereby causing information from the selected data group to be displayed in the information display region.

11. The method of claim 10, wherein the information display region is able to display information in one of a row and a column.

12. The method of claim 10, wherein a plurality of information display regions and a plurality of data-group-selecting controls is presented on the at least one electronic display, each data-group-selecting control being associated with a respective information display region.

13. The method of claim 10, wherein the data-group-selecting control enables a user to select a data group from among a defined sub-set of the data groups accessible to the electronic device.

14. The method of claim 10, wherein the data-group-selecting control is a drop-down box that presents a list of data group choices from among the data groups accessible to the electronic device, and enables a user to select one of the data groups from the list.

15. The method of claim 10, wherein the data-group-selecting control is a button that enables a user to cycle through a list of data group choices from among the data groups accessible to the electronic device until a desired data group choice is reached.

16. The method of claim 10, wherein the data-group-selecting control enables a user to select a null choice, thereby causing no information to be presented in the information display region.

17. The method of claim 10, further comprising a sorting control cooperative with the information display region, the sorting control enabling a user to sort information items displayed in the information display region.

18. The method of claim 17, wherein a plurality of information display regions is presented on the at least one electronic display, and the sorting control enables a user to sort information items displayed in all information display regions according to the sorting of the information items included in the information display region that is cooperative with the sorting control.

19. The method of claim 10, wherein the electronic device is in communication with the at least one electronic display over a network.

20. The method of claim 19, wherein the network is the internet.
